(19) United States
(12) Patent Application Publication
(10) Pub. No.: US 2025/0290352 A1
(43) Pub. Date: Sep. 18, 2025

(54) VEHICLE DOOR HANDLE DEVICE

(71) Applicant: Minebea AccessSolutions Inc., Miyazaki-shi (JP)

(72) Inventors: Yuki YAMAMURA, Miyazaki (JP); Takahiro YAMADA, Miyazaki (JP)

(21) Appl. No.: 19/068,340

(22) Filed: Mar. 3, 2025

(30) Foreign Application Priority Data
Mar. 12, 2024 (JP) 2024-038088

(51) Int. Cl. E05B 77/36; E05B 85/10; E05B 85/16

(52) U.S. Cl. CPC E05B 77/36; E05B 85/16; E05B 85/103

(57) ABSTRACT

A door handle device includes a base to be attached to a door, a handle rotatably supported by the base and subjected to a pulling operation pulled toward a front surface side from an initial position and a pushing operation pushed toward a rear surface side from the initial position, a first biasing member configured to bias the pulling-operated handle toward the initial position, an end lever operably attached to the base and configured to operate in response to the pushing operation of the handle so as to drive a lock mechanism, and a buffer member configured to suppress an impact sound when the pulling-operated handle returns to the initial position. The end lever is provided with a holding portion configured to hold the buffer member.

### CROSS REFERENCE TO RELATED APPLICATION

This application claims benefit of priority to Japanese Patent Application 2024-038088, filed on Mar. 12, 2024, the entire content of which is incorporated herein by reference.

### BACKGROUND

### Technical Field

The present invention relates to a vehicle door handle device.

### Background Art

JP 2001-288935 A discloses a door handle device including a handle that is pushed and pulled by a user outside a vehicle. By the pulling operation, the user can open the door in an unlocked and unlatched state. During the pushing operation, a transmission member operates and a lock mechanism is driven. The handle is biased to be located at an initial position when not operated.

In the above case, when the user releases his/her hand from the handle during the pulling operation, the handle returns to the initial position by the biasing force. At this time, the handle may collide with a component of the door handle device, generating an impact sound. Although it is conceivable to provide a member for suppressing the impact sound, this may lead to an increase in the size of the door handle device or a deterioration in assemblability.

### SUMMARY

An object of the present invention is to improve quietness of a door handle device while maintaining a size and assemblability of the door handle device.

An aspect of the present invention provides a door handle device for vehicles including a base to be attached to a vehicle door, a handle rotatably supported by the base and subjected to a pulling operation pulled toward a front surface side from an initial position and a pushing operation pushed toward a rear surface side from the initial position, a first biasing member configured to bias the pulling-operated handle toward the initial position, a transmission member operably attached to the base and configured to operate in response to the pushing operation of the handle so as to drive a lock mechanism, and a buffer member configured to suppress an impact sound when the pulling-operated handle returns to the initial position. The transmission member is provided with a holding portion configured to hold the buffer member.

According to the above-described configuration, when the handle returns to the initial position by the biasing force after the pulling operation, the handle comes into contact with the buffer member. This makes it possible to suppress the impact sound and to improve the quietness of the door handle device. The buffer member is held by the transmission member, which is conventionally provided to drive the lock mechanism. It is easy to avoid an increase in the size of the door handle device as compared with a case where the buffer member is installed at a different location away from the transmission member. In addition, by assembling the buffer member to the transmission member to constitute a sub-assembly and then assembling the sub-assembly to the base in the same manner as in the related art, a configuration for suppressing the impact sound is added to the door handle device. That is, while adding the function of suppressing the impact sound, the assemblability of the door handle device is maintained.

According to the present invention, it is possible to improve the quietness of the door handle device while maintaining the size and assemblability of the door handle device.

### BRIEF DESCRIPTION OF DRAWINGS

FIG. 1 is a block diagram of a door handle device and a door latch device according to a first embodiment.

FIG. 2 is a front-side perspective view of the door handle device.

FIG. 3 is a rear-side perspective view of the door handle device from which a cover is removed.

FIG. 4 is a cross-sectional view taken along IV-IV of FIG. 2.

FIG. 5 is an exploded perspective view of the door handle device.

FIG. 6 is a partially exploded perspective view of the door handle device.

FIG. 7 is a perspective view of an end lever and a buffer member.

FIG. 8 is a cross-sectional view of the door handle device.

FIG. 9 is a cross-sectional view of the door handle device in a push-operated state of a handle.

FIG. 10 is an exploded perspective view of an end lever and a buffer member of a door handle device according to a second embodiment.

FIG. 11 is an exploded perspective view of the end lever and buffer member of the door handle device.

FIG. 12 is a front-side perspective view of the end lever and buffer member of the door handle device.

FIG. 13 is a rear-side perspective view of the end lever and buffer member of the door handle device.

FIG. 14 is a cross-sectional view of the door handle device.

### DETAILED DESCRIPTION

Hereinafter, an embodiment of the present invention will be described with reference to the drawings.

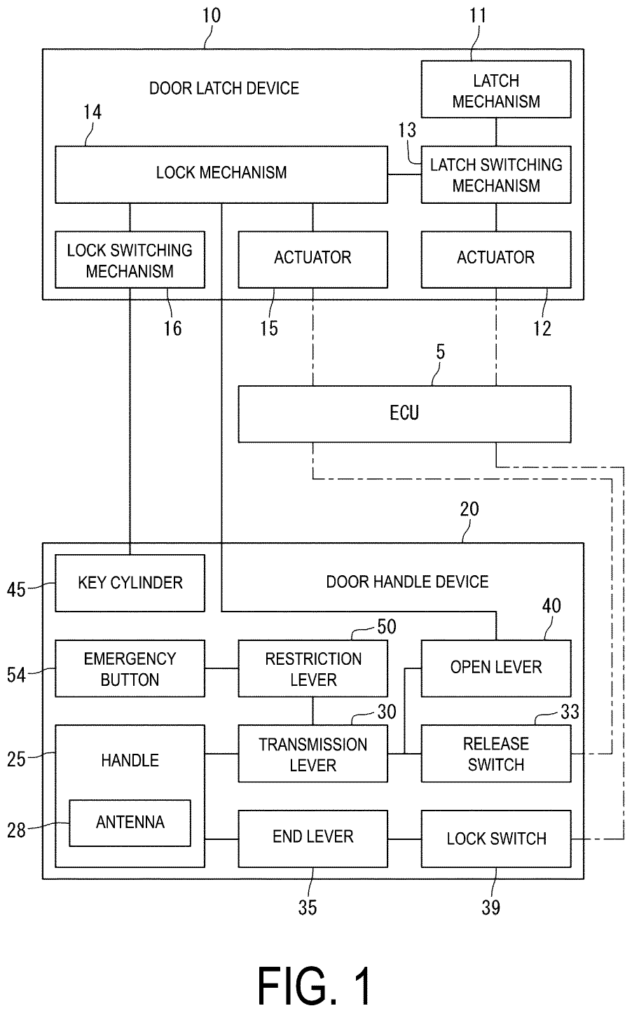

Referring to FIGS. 1 to 3, a door handle device 20 according to an embodiment of the present invention is attached to an outer panel (door panel) 2 of a door 1, and enables the door 1 in a closed state to be opened by operating a door latch device 10 attached to the same door 1. The door handle device 20 of the present embodiment is for a left side door in which a hinge shaft extends in a vehicle height direction. However, the door handle device 20 may also be used for a right side door, a slide door, or a back door.

An X direction in the accompanying drawings is a vehicle length direction, a direction indicated by an arrow is a rear side, and a direction opposite to the arrow is a front side. A Y direction is a vehicle width direction, a direction indicated by an arrow is an inner side (vehicle interior side), and a direction opposite to the arrow is an outer side (vehicle exterior side). A Z direction is a vehicle height direction, a direction indicated by an arrow is an upper side, and a direction opposite to the arrow is a lower side.

Referring to FIG. 1, the door handle device 20 is connected to an electronic control unit (ECU) 5 mounted on a vehicle. The ECU 5 includes a calculation unit, a storage unit, and a communication unit (none of which are illustrated), reads out a program stored in advance in the storage unit, and executes information processing according to steps instructed by the program. A door latch device 10 is further connected to the ECU 5. The ECU 5 electrically actuates the door latch device 10 based on an input signal from the door handle device 20.

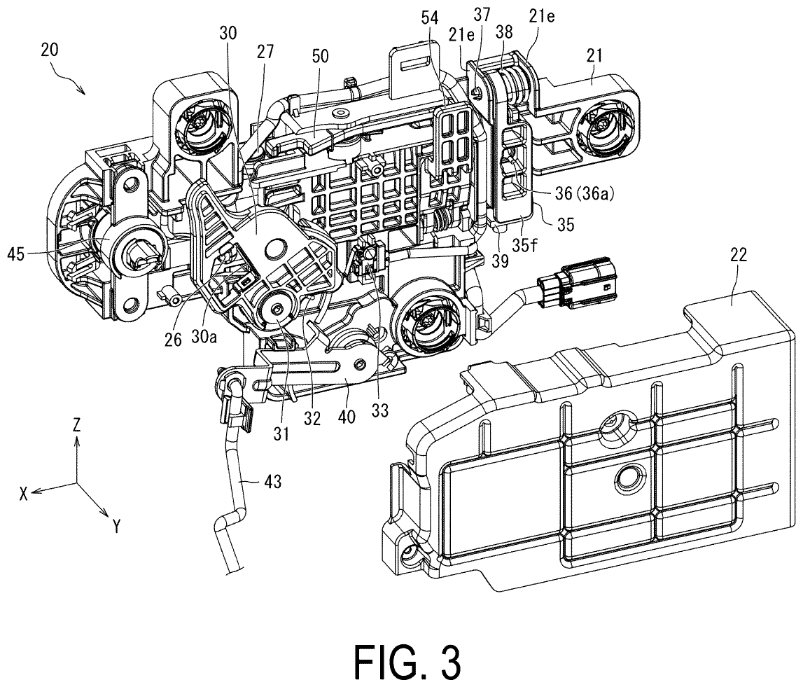

Describing the outline of the door latch device 10, the door latch device 10 is arranged along an end panel (not illustrated) of the door 1 illustrated in FIG. 3. The door latch device 10 includes a latch mechanism 11, an actuator 12, a latch switching mechanism 13, a lock mechanism 14, an actuator 15, and a lock switching mechanism 16.

The latch mechanism 11 includes a fork and a claw, and is switched between a latched state and an unlatched state. In the latched state, the fork holds a striker of the vehicle body and holds the door 1 illustrated in FIG. 3 in a closed state. In the unlatched state, the fork releases the striker, enabling the door 1 to be opened.

Switching of the latch mechanism 11 from the unlatched state to the latched state is performed by the striker entering the fork due to closing of the door 1 in the open state. Switching (opening actuation) of the latch mechanism 11 from the outside of the vehicle from the latched state to the unlatched state is performed by an operation of the door handle device 20, but is different between a normal state in which the latch mechanism 11 can be electrically actuated by the actuator 12 via the latch switching mechanism 13 and an emergency state in which the latch mechanism 11 cannot be actuated. Switching of the latch mechanism 11 by the operation of the door handle device 20 will be described in detail below.

The lock mechanism 14 is configured by a plurality of levers and the like, and is switched between an unlocked state and a locked state. In the unlocked state, the latch mechanism 11 can be switched from the latched state to the unlatched state via the latch switching mechanism 13. In the locked state, the latch mechanism 11 cannot be switched from the latched state to the unlatched state via the latch switching mechanism 13.

Switching of the lock mechanism 14 from the outside of the vehicle from the unlocked state to the locked state is performed by an operation of the door handle device 20. Switching of the lock mechanism 14 from the outside of the vehicle from the locked state to the unlocked state is performed by an operation of the door handle device 20, but is different between a normal state in which the lock mechanism 14 can be electrically actuated by the actuator 15 and an emergency state in which the lock mechanism 14 cannot be actuated. Switching of the lock mechanism 14 by the operation of the door handle device 20 will be described in detail below.

Below, the door handle device 20 according to the present embodiment will be specifically described.

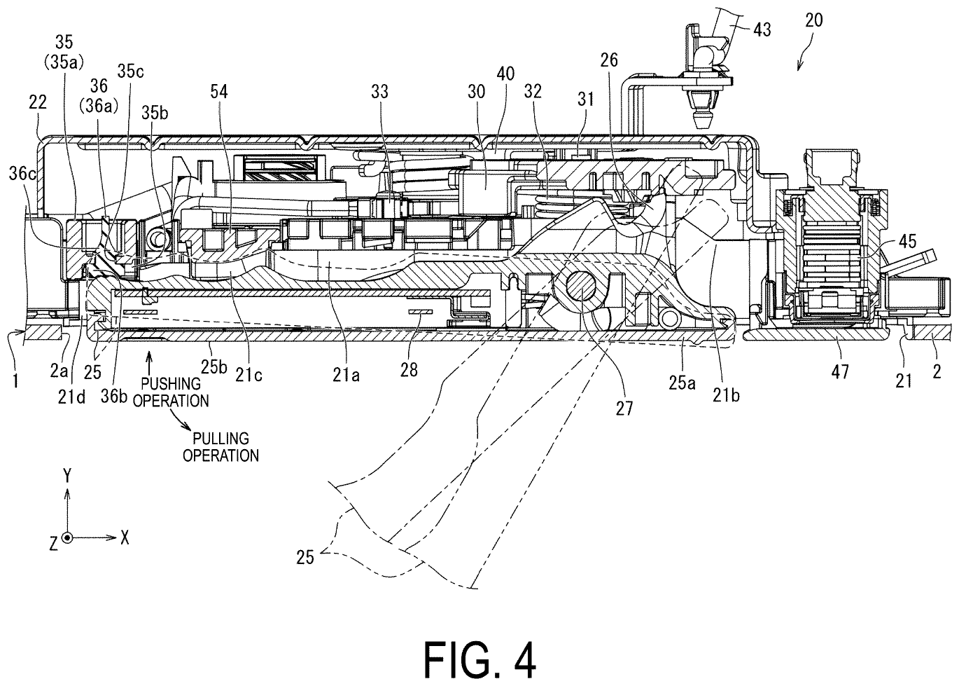

The door handle device 20 includes a configuration for electrically actuating the door latch device 10 illustrated in FIG. 1 by the ECU 5 in a normal state and manually actuating the same in an emergency state. Specifically, as illustrated in FIGS. 1 to 4, the door handle device 20 includes a base 21, a cover 22, a handle 25, and a transmission lever 30. In addition, the door handle device 20 includes a release switch 33, an end lever 35 (transmission member), a lock switch 39, an open lever 40, a key cylinder 45, a restriction lever 50, and an emergency button 54.

The base 21 is attached to a rear surface of an outer panel 2 of a door 1. The base 21 is provided with a recessed portion 21a formed by recessing a front surface toward the rear surface side. Although not illustrated in detail, the outer panel 2 is provided with an opening 2a through which the front surface of the base 21 is exposed, and the recessed portion 21a is exposed to the vehicle external side. The recessed portion 21a has a rectangular shape with rounded corners that is elongated in the vehicle length direction when viewed from a side, and forms a bottom portion offset toward the vehicle interior side with respect to an outer surface of the outer panel 2. The cover 22 covers the base 21 from the rear surface side and protects a member attached to the rear surface of the base 21.

The handle 25 is a flush handle elongated in the vehicle length direction and extending flush with the outer panel 2. The handle 25 is rotatably supported by the base 21 via a rotary shaft 27 extending in the vehicle height direction in a state of being accommodated in the recessed portion 21a, and is rotationally operated both in a normal state and in an emergency state. The handle 25 is provided with an operation portion 26 that protrudes inward in the vehicle width direction and operates the transmission lever 30. The transmission lever 30 is rotatably supported on the rear surface of the base 21 via a rotary shaft 31 extending in the vehicle width direction and is arranged adjacent to the vehicle interior side of the handle 25. The transmission lever 30 includes an operation receiving portion 30a that receives an operation by the operation portion 26, and rotates in conjunction with the rotation of the handle 25 both in a normal state and in an emergency state.

The bottom portion of the recessed portion 21a is provided with three openings 21b, 21c, and 21d that communicate an internal space of the recessed portion 21a of the base 21 with a rear surface-side space of the base 21. The openings 21b, 21c, and 21d are aligned in the vehicle length direction. The transmission lever 30, the release switch 33, the end lever 35, the lock switch 39, the open lever 40, the key cylinder 45, and the emergency button 54 are attached to the rear surface of the base 21. The transmission lever 30 is arranged to cover the opening 21b on one side in the vehicle length direction, and the operation portion 26 protrudes to the rear surface side of the base 21 through the opening 21b. The end lever 35 is arranged to cover the opening 21d on the other side in the vehicle length direction. The emergency button 54 is arranged to cover the central opening 21c.

The release switch 33 is a detection unit for actuating the latch mechanism 11 and the lock mechanism 14 illustrated in FIG. 1 in a normal state and is arranged adjacent to the transmission lever 30. The end lever 35 and the lock switch 39 are configured to actuate the lock mechanism 14 illustrated in FIG. 1 in a normal state and are arranged on the vehicle interior side of a front end portion of the handle 25 in the vehicle length direction.

The open lever 40 is configured to rotate in conjunction with the rotation of the transmission lever 30 in an emergency state to actuate the latch mechanism 11 illustrated in FIG. 1 and is arranged below the transmission lever 30. The key cylinder 45 is configured to actuate the lock mechanism 14 illustrated in FIG. 1 in an emergency state and is arranged adjacent to the rear side of the handle 25 in the vehicle length direction.

The restriction lever 50 is configured to restrict transmission of an operating force of the handle 25 to the latch mechanism 11 illustrated in FIG. 1 via the open lever 40 by restricting rotation of the handle 25 via the transmission lever 30 in a normal state. The emergency button 54 is configured to release restriction by the restriction lever 50 in an emergency.

The control of the door latch device 10 by the ECU 5 illustrated in FIG. 1 is executed when authentication with an electronic key (not illustrated) carried by a user is established. That is, in a normal state, when the authentication with the electronic key is not established, the operation of the door latch device 10 by the ECU 5 is not executed. An antenna 28 for the ECU 5 to wirelessly communicate with the electronic key is accommodated in the handle 25.

Below, an operation including the door latch device 10 according to the operation of the door handle device 20 will be described. Note that the rotary shaft 27 penetrates the handle 25 slightly on one side (rear side) with respect to a center portion of the handle 25 in the vehicle length direction, and the handle 25 can be rotationally operated in both directions from the initial position. A pulling operation is an operation of pulling the other end portion (front end portion) in a longitudinal direction forward (that is, toward the vehicle external side or the front surface side of the handle 25) and causes the handle 25 to rotate counterclockwise when viewed from above. The pulling operation is substantially the same as an operation of pushing one end portion (rear end portion) in the longitudinal direction inward (i.e., toward the vehicle interior side or the rear surface side of the handle 25). A pushing operation is an operation of pushing the other end portion in the longitudinal direction inward and causes the handle 25 to rotate clockwise when viewed from above.

### (Opening Operation in Normal State)

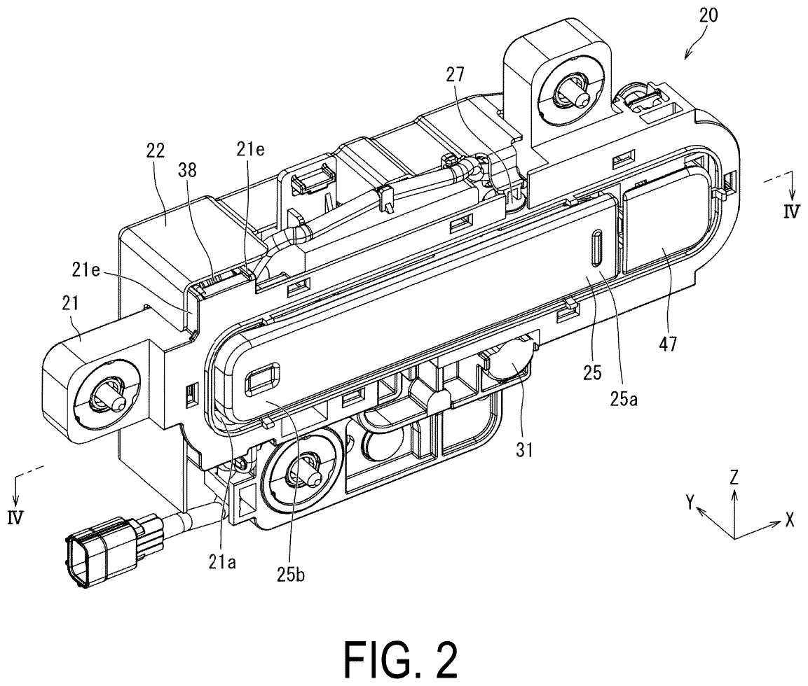

When operating the door latch device 10 to open in a normal state, a portion 25a, which is positioned on the rear side of a rotary shaft 27, of the handle 25 at the initial position indicated by a solid line in FIG. 3 is pushed inward in the vehicle width direction. By the operation, the handle 25 rotates counterclockwise in FIG. 2 when viewed from above, and the transmission lever 30 pivotally supported by the rotary shaft 31 rotates counterclockwise when viewed from the vehicle exterior side. By the rotation of the transmission lever 30, the release switch 33 is switched from an off state to an on state and outputs an opening signal. As a result, the ECU 5 illustrated in FIG. 1 electrically switches the lock mechanism 14 from the locked state to the unlocked state by the actuator 15, and then electrically switches the latch mechanism 11 from the latched state to the unlatched state via the latch switching mechanism 13 by the actuator 12. Thus, the door 1 illustrated in FIG. 3 can be opened.

The rotation of the handle 25 by the operation of the rear-side portion 25a is restricted at a normal operation position indicated by the dash-dot line in FIG. 3 due to the contact of the transmission lever 30 with the restriction lever 50. In this restricted state, the release switch 33 of the transmission lever 30 can be operated as described above, but the open lever 40 cannot be operated (pressed). That is, the operating force of the handle 25 is not transmitted to the open lever 40 via the transmission lever 30 in the normal state. As a result, it is possible to prevent the electric switching and manual switching of the latch mechanism 11 from competing with each other to cause a malfunction in the door latch device 10.

### (Lock Operation in Normal State)

When the door latch device 10 is operated in a normal state, a portion 25b, which is positioned on the front side of the rotary shaft 27, of the handle 25 at the initial position is pushed inward in the vehicle width direction. By the pushing operation, the handle 25 rotates clockwise toward a normal lock operation position indicated by the broken line in FIG. 3 when viewed from above, and the end lever 35 pivotally supported by a rotary shaft 37 is pushed by the handle 25 and rotates. By the rotation of the end lever 35, the lock switch 39 is switched from an off state to an on state and outputs a lock signal. As a result, the ECU 5 illustrated in FIG. 1 electrically switches the lock mechanism 14 from the unlocked state to the locked state by the actuator 15. Thus, the door 1 illustrated in FIG. 3 cannot be opened. Note that the rotation of the handle 25 during the pushing operation is stopped when the rear surface of the handle 25 comes into contact with the bottom portion of the recessed portion 21a (particularly, a portion between the opening 21b and the opening 21c).

### (Opening Operation in Emergency State)

An opening operation of the door latch device 10 in an emergency state is performed in the order of an unlocking operation of the lock mechanism 14 and an unlatching operation of the latch mechanism 11 illustrated in FIG. 1.

When unlocking the door latch device 10 in an emergency state, the cover 47 in FIG. 2 is opened outward in the vehicle width direction, and a keyhole of the key cylinder 45 is exposed to the outside of the vehicle. Thereafter, a mechanical key (not illustrated) is inserted into the key cylinder 45 and rotationally operated. As a result, the lock mechanism 14 to which the operating force is transmitted via a transmission member (not illustrated) and the lock switching mechanism 16 illustrated in FIG. 1 is manually switched from the locked state to the unlocked state.

Subsequently, when the door latch device 10 is operated to open in an emergency state, the rear-side portion 25a of the handle 25 is pushed inward in the vehicle width direction. By the operation, in FIG. 2, the handle 25 rotates counterclockwise when viewed from above, and the transmission lever 30 rotates clockwise when viewed from the vehicle exterior side. However, in an emergency state, the latch mechanism 11 cannot be electrically actuated to open. In addition, the rotation of the handle 25 by the operation of the rear-side portion 25a is restricted at the normal operation position indicated by the dash-dot line in FIG. 3 due to the contact of the transmission lever 30 with the restriction lever 50 in the same manner as the operation in a normal state.

Next, in an emergency state, the emergency button 54 exposed by the rotation of the handle 25 is pushed inward in the vehicle width direction. As a result, the emergency button 54 pivotally supported by a rotary shaft 55 rotates, and a restriction lever 50 pivotally supported by a rotary shaft 51 rotates away from the transmission lever 30. As a result, the rotational restriction of the transmission lever 30 by the restriction lever 50 is released.

By releasing the restriction of the transmission lever 30, the handle 25 can be rotated in the pulling operation direction to an emergency operation position illustrated by the two-dot chain line in FIG. 3. By the additional pulling operation, the transmission lever 30 is further rotated to press the open lever 40. As a result, the open lever 40 pivotally supported by a rotary shaft 41 rotates downward. As a result, the operating force of the handle 25 is transmitted to the latch mechanism 11 via the transmission lever 30, the open lever 40, a rod 43, the lock mechanism 14 illustrated in FIG. 1, and the latch switching mechanism 13, and the latch mechanism 11 is manually switched from the latched state to the unlatched state. As a result, the door 1 illustrated in FIG. 3 can be opened.

Regardless of the normal state and the emergency state, when the user releases his/her hand during the pulling operation, the transmission lever 30 and the handle 25 engaged therewith return to the initial position by a first biasing force of a first biasing member 32. Note that, at this time, the state of the release switch 33 is switched. The first biasing member 32 is a torsion coil spring as an example and is mounted on an outer periphery side of the rotary shaft 31 that pivotally supports the transmission lever 30. The first biasing force by the first biasing member 32 is transmitted from the operation receiving portion 30a of the transmission lever 30 to the handle 25, whereby the pulled handle 25 is biased toward the initial position.

When the user releases his/her hand during the pushing operation, the end lever 35 and the handle 25 in contact therewith return to the initial position by a second biasing force of a second biasing member 38. Note that, at this time, the state of the lock switch 39 is switched. The second biasing member 38 biases the end lever 35 toward a side opposite to a swinging direction of the end lever 35 during the pushing operation. The handle 25 is held at the initial position by the actions of the first biasing member 32 and the second biasing member 38 when no external force is applied.

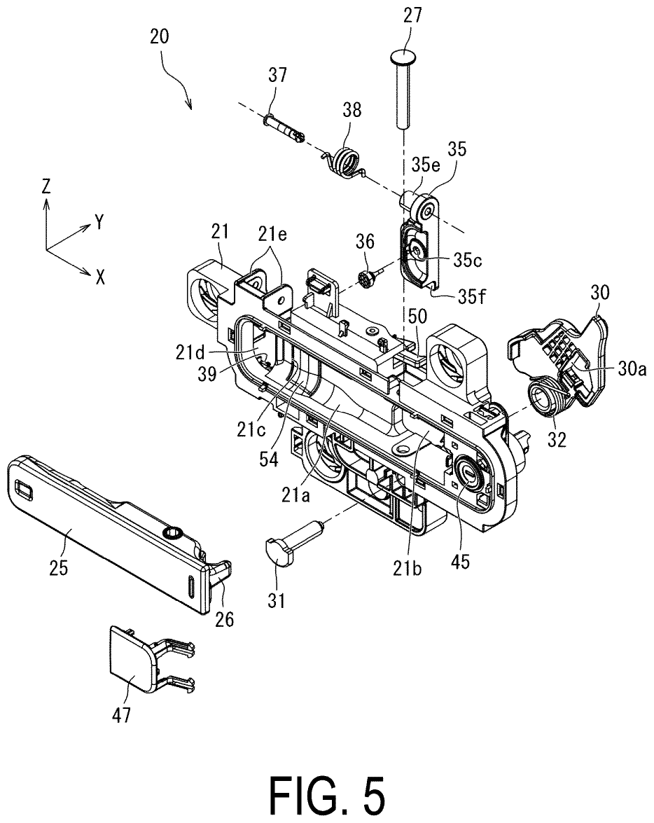

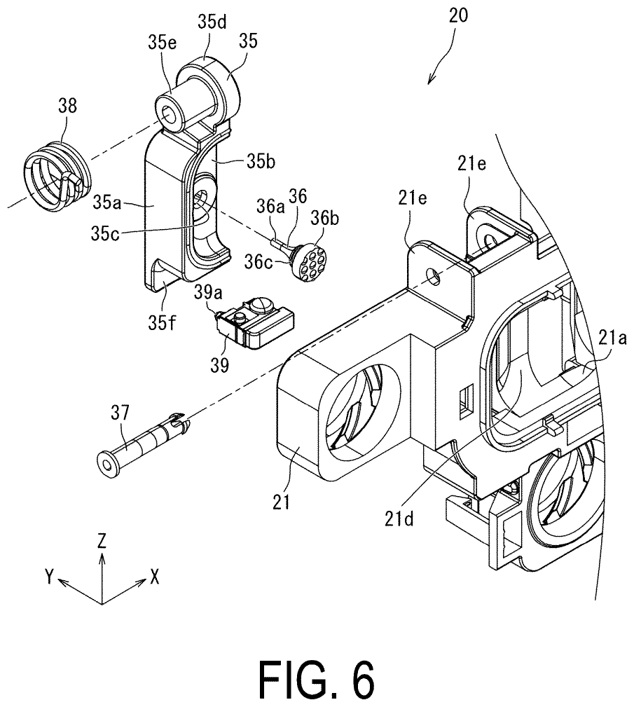

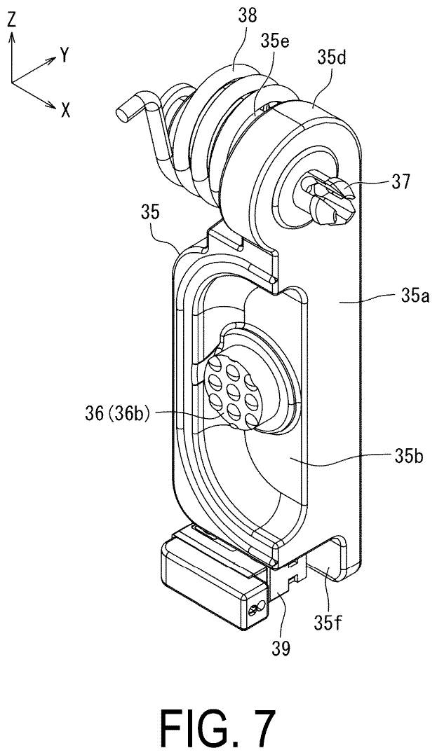

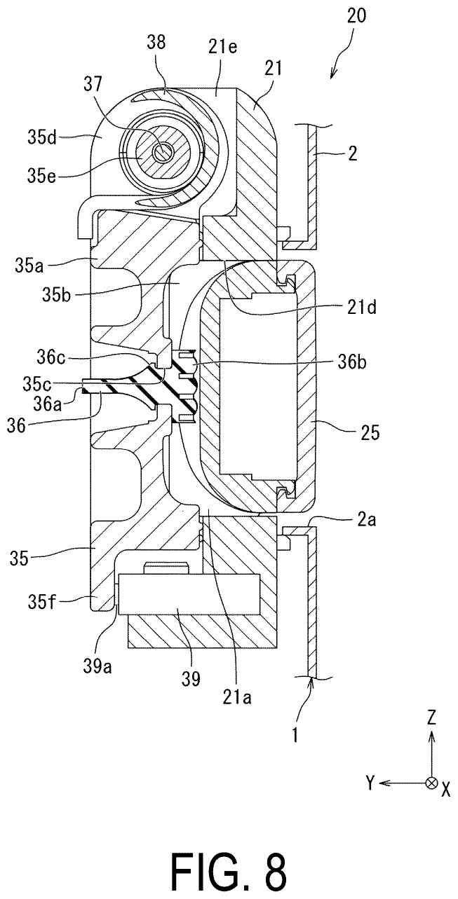

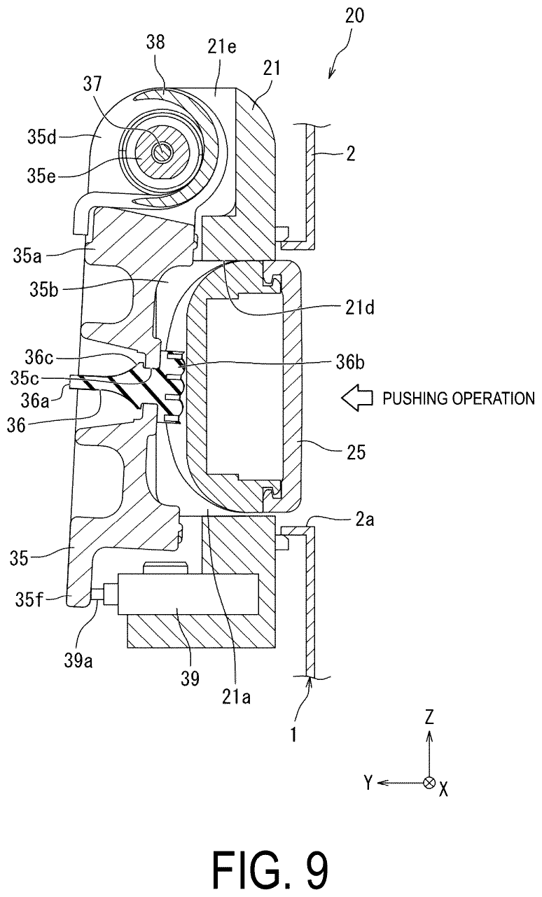

Referring to FIGS. 5 to 9, the end lever 35 includes a main body portion 35a, a holding portion 35b, an attachment hole 35c, a flange portion 35d, a shaft portion 35e, and a switch operation portion 35f. The end lever 35 is assembled with the buffer member 36 and the rotary shaft 37 in addition to the second biasing member 38.

The main body portion 35a has a vertically long rectangular shape when viewed in the vehicle width direction. A front surface side (vehicle external side) of the main body portion 35a faces a rear surface of the handle 25 in the vehicle width direction. The holding portion 35b is formed by recessing the front surface side of the main body portion 35a toward the rear surface side (vehicle interior side). The holding portion 35b is surrounded by an inner peripheral surface extending in the vehicle width direction on both sides in the vehicle height direction and on the other side in the vehicle length direction. On the other hand, the holding portion 35b is open on the vehicle external side and on one side in the vehicle length direction so as to be able to accommodate the other end portion in the longitudinal direction of the handle 25. The attachment hole 35c is formed to penetrate through the main body portion 35a and opens to a bottom surface of the holding portion 35b. Note that the rear surface of the main body portion 35a may be thinned as illustrated in the drawing, thereby reducing weights of the end lever 35 and hence the door handle device 20.

The buffer member 36 is made of an elastic material, such as rubber or elastomer. The buffer member 36 has a shank portion 36a, a to-be-contacted portion 36b, and a retaining portion 36c. The shank portion 36a has a thin shaft shape. The to-be-contacted portion 36b is provided at one end of the shank portion 36a and extends in a radial direction of the shank portion 36a. In the present embodiment, the to-be-contacted portion 36b has a cylindrical shape as a whole and has a plurality of projections on an end surface thereof. The retaining portion 36c is provided on the shank portion 36a. The retaining portion 36c has a conical shape and is arranged at an axial interval from the to-be-contacted portion 36b, with a conical bottom surface thereof facing a rear surface of the to-be-contacted portion 36b.

The buffer member 36 is assembled to the end lever 35 in advance before the end lever 35 is assembled to the base 21. During the assembling, the other end of the shank portion 36a (an end on a side opposite to the to-be-contacted portion 36b) is inserted into the attachment hole 35c. When an assembling worker pinches and pulls the other end of the shank portion 36a exposed from the opening of the attachment hole 35c, the retaining portion 36c is elastically deformed and passes through the attachment hole 35c. When the retaining portion 36c completely passes through the attachment hole 35c, the retaining portion 36c returns to its original shape. The conical bottom surface of the retaining portion 36c comes into close contact with the rear surface of the main body portion 35a, and the rear surface of the to-be-contacted portion 36b comes into close contact with the bottom surface of the holding portion 35b. In this way, the buffer member 36 is mounted to the end lever 35.

The flange portion 35d has a spring seat surface protruding upward from the main body portion 35a and facing toward the other side in the vehicle length direction. The shaft portion 35e protrudes from the spring seat surface toward the other side in the vehicle length direction. The second biasing member 36 is a torsion coil spring and is provided on the outer periphery side of the shaft portion 35e. On the other hand, the base 21 is provided with a pair of support flanges 21e protruding toward the rear surface side on an upper side of the opening 21d. In a state where the second biasing member 38 is mounted on the shaft portion 35e, the shaft portion 35e and the flange portion 35d are sandwiched between the pair of support flanges 21e. In this state, the rotary shaft 37 is inserted through the pair of support flanges 21e and the shaft portion 35e. Further, one end of the second biasing member 38 is locked to the base 21, and the other end of the second biasing member 38 is locked to the rear surface of the main body portion 35a. Accordingly, the end lever 35 is biased to close the opening 21d, and the front surface of the main body portion 35a comes into contact with an edge portion of the opening 21d from the rear surface side. The to-be-contacted portion 36b of the buffer member 36 is exposed to the recessed portion 21a of the base 21 through the opening 21d.

The switch operation portion 35f protrudes downward from the main body portion 35a, that is, toward a side opposite to the flange portion 35d and the shaft portion 35e in the vertical direction. The switch operation portion 35f has a plate shape where a plate thickness direction is oriented in the vehicle width direction. A rear surface of the switch operation portion 35f is substantially flush with the rear surface of the main body portion 35a, while a plate thickness of the switch operation portion 35f is smaller than a plate thickness of the main body portion 35a. A front surface of the switch operation portion 35f faces the base 21 below the opening 21d.

On the other hand, a lock switch 39 is fixed to the base 21 on the lower side and the rear surface side of the opening 21d. The lock switch 39 has an operated portion 39a that advances toward the vehicle interior side or retracts toward the vehicle exterior side, and the operated portion 39a is biased to advance toward the vehicle interior side. When the handle 25 is at the initial position, the end lever 35 is biased to close the opening 21d as described above. At this time; however, the switch operation portion 35f presses the operated portion 39a toward the vehicle external side so as to retract the operated portion.

As described above, the door handle device 20 according to the present embodiment includes the base 21 to be attached to the door 1, the handle 25 rotatably supported by the base 21 and subjected to the pulling operation and the pushing operation from the initial position, the first biasing member 32 configured to bias the pulling-operated handle 25 toward the initial position, the end lever 35 operably attached to the base 21 and configured to operate in response to the pushing operation of the handle 25 so as to drive the lock mechanism 14, and the buffer member 36 configured to suppress an impact sound when the pulling-operated handle 25 returns to the initial position. The end lever 35 is provided with the holding portion 35b configured to hold the buffer member 36.

When the user releases his/her hand from the handle 25 during the pulling operation and the handle 25 returns to the initial position by the first biasing force, the rear surface of the handle 25 first comes into contact with the to-be-contacted portion 36b of the buffer member 36 held by the end lever 35 from the vehicle external side. Before the rear surface of the handle 25 collides with a peripheral member, such as the bottom portion of the recessed portion 21a, the rear surface comes into contact with the buffer member 36, and the impact based on the first biasing force is absorbed by elastic deformation of the buffer member 36. Therefore, the impact sound is suppressed and the quietness of the door handle device 20 is improved.

Compared to a case where the buffer member 36 is arranged at a different location away from the end lever 35, for example, at the bottom portion of the recessed portion 21a, it is possible to avoid an increase in the size of the door handle device 20 in the vehicle width direction or the vehicle length direction. Further, as described above, the buffer member 36 is assembled to the end lever 35 in advance, and the end lever 35 with the buffer member 36 is assembled to the base 21. Therefore, compared to a configuration in which the end lever 35 is provided while the buffer member 36 is not provided, the assemblability of the door handle device 20 is not impaired. In this way, the quietness of the door handle device 20 can be improved while maintaining the size and assemblability of the door handle device 20.

The end lever 35 is swingably attached to the base 21, and the door handle device 20 further includes the second biasing member 38 that biases the end lever 35 toward a side opposite to the swinging direction of the end lever 35 during the pushing operation. The second biasing force by the second biasing member 38 is greater than the first biasing force by the first biasing member 32. Therefore, even when the rear surface of the handle 25 collides with the buffer member 36, it is possible to prevent the end lever 35 from swinging, thereby preventing malfunction of the lock switch 39. The buffer member 36 applies a reaction force to the handle 25 during the pushing operation. Therefore, it is conceivable that an operating force necessary for the pushing operation increases, but the increase in the operating force can be avoided by adjusting the second biasing force (the spring constant of the second biasing member 38).

The holding portion 35b is formed by recessing the front surface of the end lever 35 facing the handle 25. Therefore, the end lever 35 can be arranged on the base 21 without interfering with the handle 25.

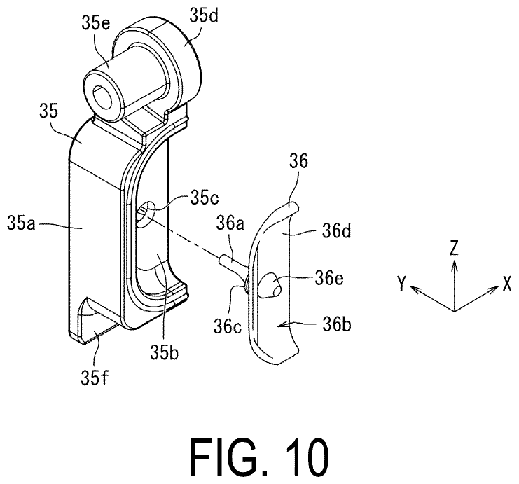

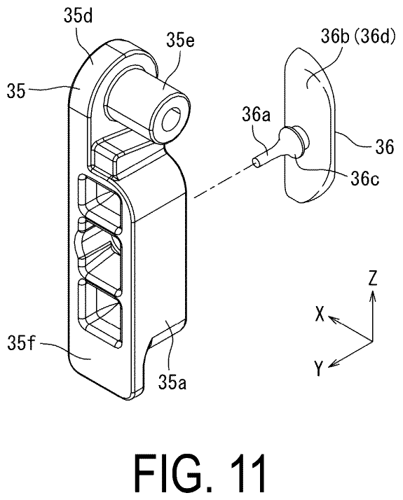

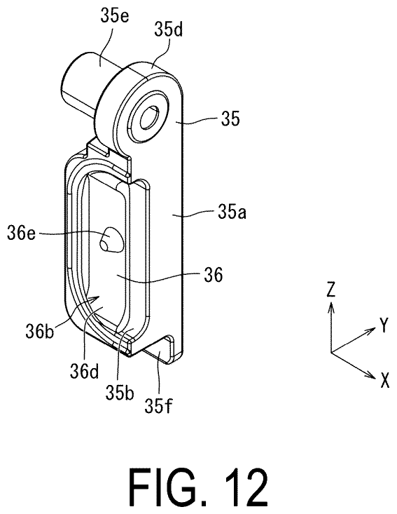

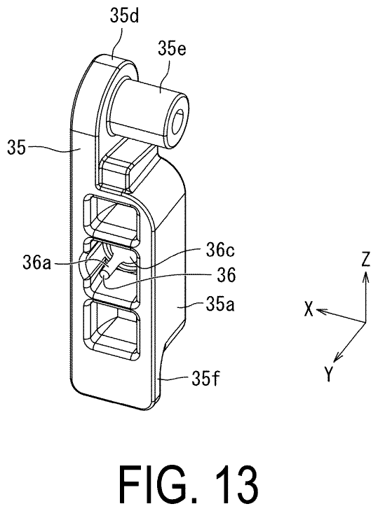

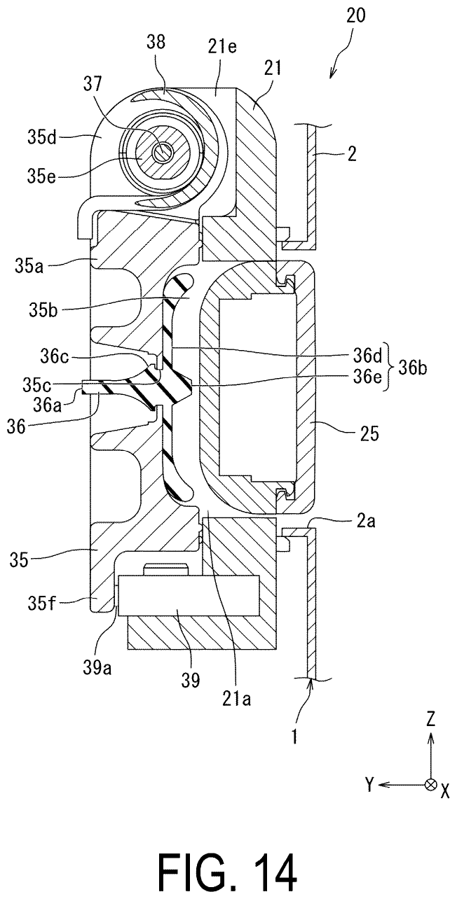

A door handle device 20 according to a second embodiment will be described with reference to FIGS. 10 to 14, focusing on differences from the above-described embodiment. In the present embodiment, the buffer member 36 includes the shank portion 36a, the to-be-contacted portions 36b, and the retaining portions 36c, as in the first embodiment. The to-be-contacted portion 36b has a larger area when viewed from the vehicle external side, compared to the first embodiment. The to-be-contacted portion 36b includes a covering portion 36d in close contact with substantially the entire inner surface of the holding portion 35b, and a projection 36e protruding from the covering portion 36d toward the vehicle external side.

Also in the present embodiment, similarly to the first embodiment, it is possible to improve the quietness of the door handle device 20 while maintaining the size and assemblability of the door handle device 20. Although the end lever 35 is exposed during the pulling operation, the to-be-contacted portion 36b is provided to cover substantially the entire holding portion 35b, so the aesthetic appearance of the back side of the handle 25 can be highly maintained.

Although the embodiments have been described above, the above-described configuration is merely an example and can be appropriately changed within the scope of the gist of the present invention.

What is claimed is:

1. A door handle device for vehicles comprising:
a base to be attached to a vehicle door;
a handle rotatably supported by the base and subjected to a pulling operation pulled toward a front surface side from an initial position and a pushing operation pushed toward a rear surface side from the initial position;
a first biasing member configured to bias the pulling-operated handle toward the initial position;
a transmission member operably attached to the base and configured to operate in response to the pushing operation of the handle so as to drive a lock mechanism; and
a buffer member configured to suppress an impact sound when the pulling-operated handle returns to the initial position,
wherein the transmission member is provided with a holding portion configured to hold the buffer member.

2. The door handle device for vehicles according to claim 1, wherein
the transmission member is swingably attached to the base, and
the door handle device further includes a second biasing member configured to bias the transmission member toward a side opposite to a swinging direction of the transmission member during the pushing operation.

3. The door handle device for vehicles according to claim 2, wherein a second biasing force by the second biasing member is greater than a first biasing force by the first biasing member.

4. The door handle device for vehicles according to claim 1, wherein the holding portion is formed by recessing a front surface of the transmission member, the front surface facing the handle.
